(19) United States
(12) Patent Application Publication
(10) Pub. No.: US 2003/0014837 A1
(43) Pub. Date: Jan. 23, 2003

(54) RETRACTABLE HANDLE FOR A CASE

(76) Inventor: James Tsai, Taichung Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/906,642

(22) Filed: Jul. 18, 2001

(51) Int. Cl. E05B 1/00

(52) U.S. Cl. 16/113.1

(57) ABSTRACT

A retractable handle, which is provided on a case, comprising Two rail housings, provided substantial parallel on the lateral sides of the case. Between each of the rail housings and the case forming a slide rail respectively. A U shaped handle device, having two connecting means at the two ends of said handle device. The connecting means of said handle device are elastic belts, each of which slidely engaged with said slide rails on the case respectively. Whereby said handle device can move between a collapsed position, in which said handle device moved toward the case and being against on the case, and a extended position, in which said handle device moved outward the case for a predetermined distance.

### FIELD OF THE INVENTION

The present invention relates to a handle of the case and, more particularly, to a retractable handle for a case.

### BACKGROUND OF THE INVENTION

The U.S. Pat. No. 5,806 disclosed a retractable handle for a wheeled luggage. And most of the structures of the retractable handles in the market are as same as the disclosed invention. Inventor found such structure will provide two problems. First, the conventional retractable handle is a rigid body and take too much space of the receiving chamber of the luggage. That will loose the capacity of the luggage. Second, the disclosed structure is complex, which increased the cost of manufacture as well as increasing the total weight of the wheeled luggage.

### SUMMARY OF THE INVENTION

The primary objective of the present invention is to provide a retractable handle, which take less space of a case.

The other objective of the present invention is to provide a retractable handle, which has a simple structure.

In keeping with the principle of the present invention, the retractable handle of the present invention, which is provided on a case, comprising two slide rails provided substantial parallel on the case. An elongated handle device, having two elastic connecting means at the two ends thereof. The connecting means of the handle device slidely engaged with said slide rails respectively, whereby said handle device can move between a collapsed position, in which said handle device moved toward the case and being against on the case, and a extended position, in which said handle device moved outward the case in a predetermined distance.

### BRIEF DESCRIPTION OF THE DRAWINGS

FIG. 1 shows a exploded view of the first embodiment of the present invention.

FIG. 2 is a perspective view of the first embodiment of the present invention, shows the handle device located at the extended position.

FIG. 3 is a perspective view of the first embodiment of the present invention, shows the handle device located at the collapsed position.

FIG. 4 is a sectional view, in which shows the first engagement of the slide rail and the connecting potion of the handle device when the handle device located at the collapsed position.

FIG. 5 is a sectional view, in which shows the first engagement of the slide rail and the connecting potion of the handle device when the handle device located at the extended position.

FIG. 6 is a perspective view of the second embodiment of the present invention.

### DETAIL DESCRIPTION OF THE INVENTION

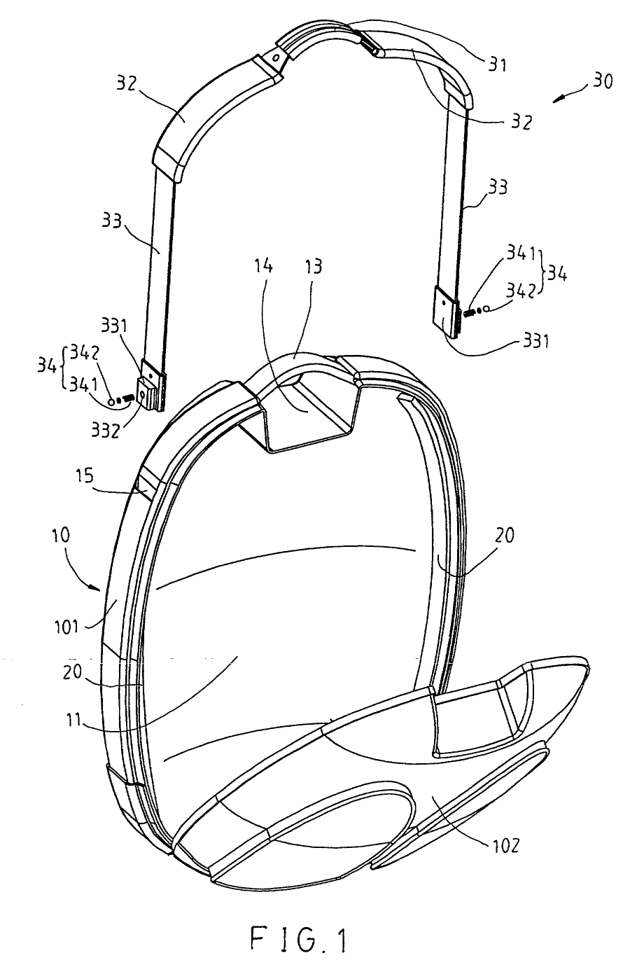

Please refer to FIG. 1, the case with a retractable handle of the embodiment of the present invention comprises:

A case body 10, which has an ellipse first case piece 101 and a second case piece 102, shaped like the first case piece 101. The bottom end of the second case piece 102 pivoted with the bottom end of the first case piece 101 and the top ends of both case pieces 101, 102 can lock together and unlock. Within the first case piece 101 and the second case piece 102 has a receiving chamber 11 for receiving goods or cloths. A case handle 13, disposed at the top side of the first case piece 101. And the first case piece 101 also has a slot 14 under the case handle for facilitating users to grip the case handle 13.

Two rail housing 20, please refer to FIGS. 1, 4 and 5, in order to fit the shape of the case body 10, each of the rail housings 20 has a curved shape. The rail housings 20 respectively fixed at the inner sides of the lateral sides of the first case piece 101 of the case body 10 to form two slide rail 21 between each of the rail housings 20 and the first case piece 101. So that, the slide rails 21 extended curved too. Two openings 15 disposed at each lateral sides of the first case piece 101, going through the top sides of the slide rails 21. Within each of the slide rails 21, two slots 213, 214 provided at the inner sides of the first case piece 101, positioned at the top sides and the bottom sides thereof. The slots 213, 214 will be discussed later.

A handle device 30, substantially is a U shape belt, which has a grip portion 31, two curved portions 32 and two connecting portions 33. Wherein, the grip portion 31 located at the central part of the handle device 30, which is designed for users to grip it by hand. The curved potions 32 are arch rigid pieces, provided at two ends of the grip potion 31. The curved potions 32 can be made of mental or plastic to keep the handle device 30 with a predetermined shape. The connecting potions 33 are made of composite material, like carbon fiber or glass fiber, to form two elongated belts with elastic, each of which locating at the outer ends of the curved potion 32, respectively. Two stop blocks 331 provided at each of the outer ends of the connecting potion 33. At each of the outer sides of the stop blocks 34 has a position means 34. In this embodiment, each of the position means 34 has a spring 341 and a mental ball 342, disposed a small slot 341 and installed into a small slot 341 on each stop block 331 in sequent. Whereby, the springs 351 can force outer end of the mental ball 352 outside the small slot 332.

It has to be mentioned here. To manufacture the handle device 30 of the present invention, we may make an elongated belt of composite material first. Next, attached a soft material on the central part of the belt to form the grip portion 31, and fixed two curved mental pieces on the belt at two side of the grip portion 31 to form the curved portions 32. And then, the rest of the belt will form the connecting portions 33.

The connecting portions 33 of the handle device 30 inserted into the slide rails 21 through the openings 15 of the case body 10, so that the handle device 30 is slidely engaged on the case body 10 with the connecting potions 33 sliding along the slide rails 21.

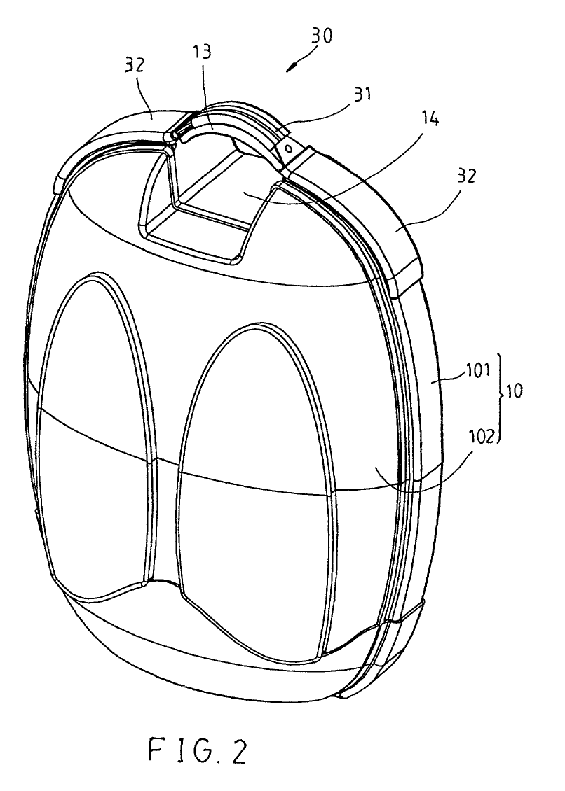

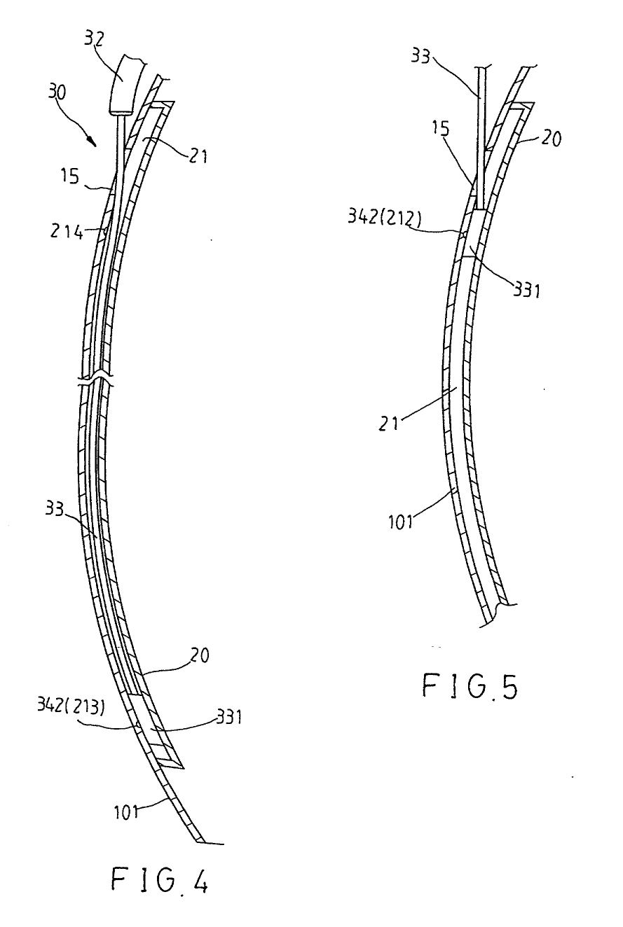

The handle device 30 can move toward the case body 10 to a collapsed position as shown in FIG. 2. In the collapsed position, the curved portions 32 being against on the case body 10, and the grip portion 31 attaching on the case grip 13 of the case body 10 for user to grip both grip portion 31 and case grip 13 by to carry the case body 10. Now please refer to FIG. 4, at this time, the outer ends of the connecting portions 33 of the handle device 30 will slide to the bottom sides of the slide rails 21. The mental balls 342 of the position means 34 will slide into the slots 213 at the bottom sides of the slide rails 21. That will provide the handle device 30 a position capacity to keep the handle device 30 locating at the collapsed position.

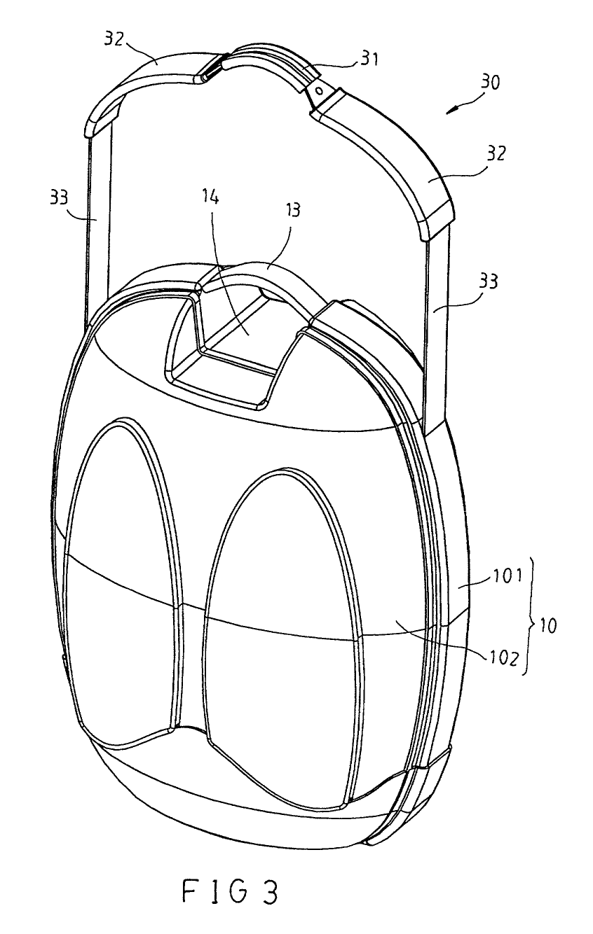

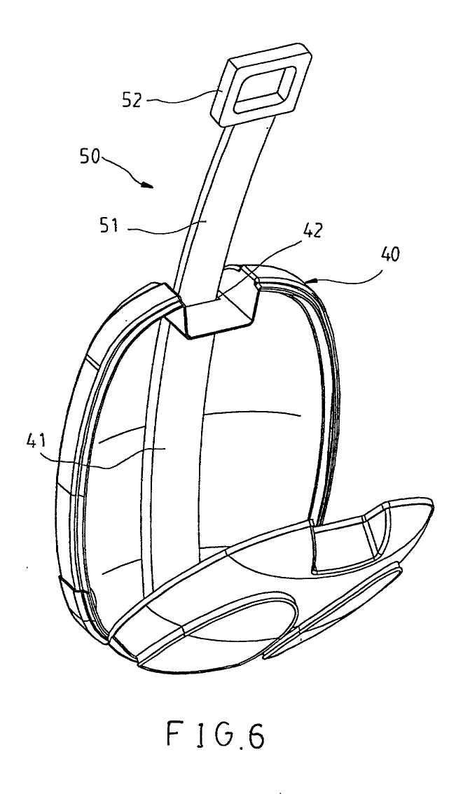

User also can pull the handle device 30 outward to an extended position as shown in FIG. 3. At this time, user can carry the case body 10 by hand or shoulder. At the extended position, please refer FIG. 5, the stop blocks 331 will keep the connecting portions 33 of the grip device 30 from escaping from the slide rails 21. And the mental balls 342 of the position device 34 will slide into the slots 212 at the top sides of the slide rails 21 to provide the handle device 30 a position capacity.

The present invention has the advantages hereunder:

1. The retractable mechanism is very simple, and takes less space of the case body 10. That will take less cost to manufacture and make the receiving chamber 11 of the case body 10 having more space to store goods.

2. The connecting portions 33 of the handle device 30 are made of elastic material, e.g. carbon fiber or glass fiber composite material, so the slide rails 21 on the case body 10 had no longer to be limited in straight. That should make the designer can design the case body 10 into any shape as he/she wanted and the structure of the case body 10 will not be limited by the handle device 30.

Now please refer to FIG. 6, a second prefer embodiment of the present invention is disclosing a wheeled luggage provided with the retractable handle, which comprise: a luggage case body 40, which has two wheels (not shown) at the bottom side thereof. A rail housing 41 fixed at the inner side of the luggage case body 40 to form a slide rail between the rail housing 41 and the case body 40. The slide rail also extended curved in this embodiment. The case body 40 has an opening 42 on the top side thereof engaged at the top end of the slide rail. A handle device 50 has a connecting means 51 and a grip 52, wherein the connecting means 51 is an elongated and elastic belt, and the grip 52 provided at the outer end of the connecting means 51. The connecting means 51 of the handle device 50 inserted into the opening 42 to slidely engage with the slide rail of the case body 40 for the handle device 50 moving between a collapsed position, in which the handle device 50 moved towards to the case body 40 with the grip 52 against on the case body 40, and an extending position, in which the handle device 50 moved outwards to the case body 40 in a predetermined distance.

### What is claim is:

1. A retractable handle, which is provided on a case, comprising:
two slide rails, provided substantial parallel on the case;
a elongated handle device, having two connecting means at the two ends of said handle device; each of said connecting means of said handle device is an elastic belt, slidely engaging with said slide rails respectively;
whereby said handle device can move between a collapsed positions in which said handle device moved toward the case and being against on the case, and a extended position, in which said handle device moved outward the case for a predetermined distance.

2. The retractable handle as defined in claim 1, wherein further comprising two rail housings, provided on the lateral sides of the case respectively to form said slide rails in between said rail housings and the case.

3. The retractable handle as defined in claim 2, wherein said rail housings provided at the inner side of the case; two openings provided at the case through said slide rails respectively for said connecting means of said handle device inserting to engage with said slide rails.

4. The retractable handle as defined in claim 1, wherein said handle device further comprising a grip portion at the central part thereof.

5. The retractable handle as defined in claim 4, wherein the case has a case handle; while said handle device moving to the collapsed position, said grip portion of said handle device being against said case handle of the case.

6. The retractable handle as defined in claim 5, wherein the case further having a slot under said case handle.

7. The retractable handle as defined in claim 1, wherein said handle device further comprising two curved means; each of which is a rigid body to shaped said handle device as a predetermined shape.

8. The retractable handle as defined in claim 1, wherein said connecting means each has a stop means for preventing said connecting means escaping from said slide rails of the case.

9. The retractable handle as defined in claim 1, wherein further comprising a position means for positioning said handle device at the collapsed position and the extended position.

10. The retractable handle as defined in claim 9, wherein said slide rails each has two slots thereof; said connecting means of said handle device has a small slot; a spring and a ball installed into said slot in sequent; said ball can engage with said slots for positioning said handle device at the collapsed position and the extended position.

11. The retractable handle as defined in claim 1, wherein said slide rails extended curved.

12. A retractable handle, which is provided on a case, comprising:
a slide rail, provided on the case;
a elongated handle device, having a connecting means at the one end thereof; said connecting means of said handle device is an elastic belt, slidely engaging with said slide rail; whereby said handle device can move between a collapsed position, in which said handle device moved toward the case, and a extended position, in which said handle device moved outward the case for a predetermined distance.

13. The retractable handle as defined in claim 12, wherein further comprising a rail housing, provided on the case to form said slide rail in between said rail housings and the case.

14. The retractable handle as defined in claim 13, wherein said rail housing provided at the inner side of the case; a opening provided at the case for said connecting means of said handle device inserting to engage with said slide rail.

15. The retractable handle as defined in claim 12, wherein further comprising means for positioning said handle device at the collapsed position and the extending position.

16. The retractable handle as defined in claim 12, wherein said slide rail extended curved.
